(19) United States
(12) Patent Application Publication
(10) Pub. No.: US 2006/0182832 A1
(43) Pub. Date: Aug. 17, 2006

(54) Semiconductor molding temperature and pressure sensors

(75) Inventor: Boon Kiat Ho, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(73) Assignee: SIF Universal Pte Ltd

(21) Appl. No.: 11/356,103

(22) Filed: Feb. 17, 2006

Related U.S. Application Data
(60) Provisional application No. 60/653,494, filed on Feb. 17, 2005.

(51) Int. Cl. B29C 35/12

(52) U.S. Cl. 425/170

(57) ABSTRACT

The present invention provides a sensing device for monitoring temperature and sensor in a semiconductor mold. The sensing device comprises a first and second optical fiber attached therein. A first Bragg grating (FBG) sensor is fabricated in the first optical fiber to measure the pressure parameter of the molten molding material in the mold. A second FBG sensor is fabricated in the second optical fiber to measure the temperature parameter of the molten molding material in the mold.

### FIELD OF THE INVENTION

The present invention generally relates to sensors used for sensing temperature and pressure in a composite structure. In particular, the invention relates to a sensing device for monitoring temperature and pressure in a semiconductor mold.

### BACKGROUND OF THE INVENTION

Molding is an essential process in the semiconductor manufacturing industry as it provides Integrated Circuits (IC) devices with a protective layer or shell. This process is known as IC packaging. Various parameters such as temperature, pressure, and speed during the transfer of molten molding material are monitored to achieve a high quality IC packaging.

One method of molding IC devices is known as transfer molding. Typically, a mold in transfer molding consists of two mold halves arranged in a vertical configuration, namely the lower mold platen and the upper mold platen. The lower mold platen comprises mold cavities, wherein the IC devices with their metal carrier or lead frames are placed. Furthermore, the lower mold consists of a resin transfer mechanism that comprises a plurality of pot and plungers. Before the transfer molding process starts, molding material such as plastic resins are placed inside the pots. A high tonnage press closes the upper mold platen on the lower mold platen, and the plastic resins in the pots are melted on preset timings. A smaller inverted press then sends the row of plungers upwards, forcing the molten plastic resin into mold cavities via respective runner channels.

Pressure and temperature measurements of the mold cavities are crucial for achieving good quality IC packaging. Reliability of the IC devices depends on the long-term stability of the IC packaging. When the IC chip is not properly packaged, the following problems may occur:

1. Package cracks due to improper molten plastics resin solidification.

2. Package surface pit holes due to air trap and improper molten plastics resin flow.

3. Unsightly snake eye aesthetic effects of the package surface.

4. Incomplete filling of the IC devices due to improper curing effects such as pressure, temperature, and velocity of plastic movement affecting the cure time.

5. Wire sweep inside the IC chip causes shorting because of uncontrolled speed of plastic flow.

6. Uneven temperature profile throughout the mold platen causing uneven cure time for each mold cavity, thus producing different package quality spread throughout the mold.

Traditional molding processes utilize an indirect way to measure the pressure and temperature within the mold platens. The pressure of the molding material is measured as a discrete data point from the transfer press plunger itself; either through a hydraulic pressure or through a mechanical screw motor current values. It does not provide for multiple mold cavities pressure measurements inside the mold.

Conventional temperature sensing methods utilizes a thermocouple disposed at the mold base that holds the mold during transfer molding. This thermocouple is a single unit and hence it can only produce single data point measurements of the mold temperature. Another disadvantage is that the thermocouple is located far away from the actual molding surface. Hence, the temperature recorded requires data compensation to display the actual temperature at the molding surface. This data compensation is calculated by manual measurements, which is a tedious process.

Measurement of the temperature and pressure parameters for the mold cavity is important for the following reasons:

1. Studies of molten plastic resin flow characteristics.

2. Plotting of the pressure and/or temperature profile in each mold cavity.

3. Providing feedback once corrective measures has been made.

4. Provide real time data collection for mold redesign.

5. Allow fast intrusive data collection for IC packaging redesign.

6. Cost saving in terms of trials and limited parameters to make corrections.

7. Instant mold thermal topography and actual molten plastic resin flow characteristics.

Conventional mold typically comprises 20 to 30 cavities fed by 6-10 plastic pallets or tablets of plastic resins. During molding, the molten plastic resin is in the semi-solid state, which is not a Newtonian fluid and thus could not be equally pressurized per se. Hence it is difficult to create equal or constant pressure throughout the mold cavities. Therefore during transfer molding, some of the mold cavities would have been filled with plastic resin faster than the other mold cavities. This phenomenon is prevalent in multiple array lead frames where there is more than one row of IC devices per lead frame.

Fiber optics sensors utilize Fiber Bragg Gratings technology to detect the pressure and temperature variance in the fiber optics line. FBG or fiber Bragg gratings consist of laser written mirrors on the fiber optics line itself to generate a series of “mirrors” or filters that can reflect different wavelengths. When the fiber optics lines experiences thermal or mechanical expansion/compression, the period between the gratings changes. This result in a different reflected wavelength that can be detected by optical means.

FBG sensor methods are described in U.S. Pat. Nos. 5,892,860, 5,563,967, and 6,659,640. In particular, U.S. Pat. No. 5,892,860 provides a FBG sensor for monitoring physical parameters in harsh environments such as oil wells and electric submersible pumps. However, the abovementioned FBG sensor methods may not be suitable for monitoring pressure and temperature simultaneously in a real time semiconductor molding process because of the following reasons:

1. Mold channel is typically small in nature and is approximately less than 2 mm (width) and 2 mm (depth).

2. Mold cavity is thin and wide, typically 20 mm by 15 mm by 2 mm deep, as an example.

3. Molding material is abrasive and the mold platen material is subjected to wear and tear during transfer molding as the material is silica or glass base compound. Thus sensors surface will be subjected to wear and tear.

4. Typical sensors are huge in comparison to the internal runner channels and mold cavity dimensions.

5. Typical sensors cannot operate at high temperatures of 200 degree Celsius.

6. Typical sensors cannot withstand a transfer force of 2 tons compacting load.

IC packaging is an important process in semiconductor manufacturing that requires accurate monitoring of the temperature and pressure of the molten molding material during transfer molding. Optical fibers are inherently small in size, which is about 125 micrometers in diameter. Hence, they are very suitable for embedding into small runner channels and mold cavities of IC devices. Therefore, there is an imperative need to have a sensing device that can provide intrusive multiple-point measurements of the pressure and temperature within the mold. This invention satisfies this need by disclosing a sensing device for monitoring pressure and temperature in a semiconductor mold. Other advantages of this invention will be apparent with reference to the detailed description.

### SUMMARY OF THE INVENTION

The present invention provides a sensing device for monitoring temperature and pressure in a semiconductor mold.

Accordingly, in one aspect, the present invention provides a sensing device for monitoring a molten molding material flowing into at least a mold cavity via at least a runner channel of a mold platen, the sensing device comprising: a sensing tip for providing contact with the molten material; an elongate sleeve having a first extremity and a second extremity, wherein the first extremity of the elongate sleeve is enclosed by the sensing tip; a fiber optic connector for coupling the sensing device to other optical devices; an adaptor for coupling the elongate sleeve to the fiber optic connector, wherein the first extremity of the adaptor is attached to the second extremity of the elongate sleeve; and wherein the second extremity of the adaptor is attached to the fiber optic connector; a first optical fiber disposed in the elongate sleeve, wherein a first extremity of the first optical fiber is coupled to first extremity of the adaptor, wherein the second extremity of the optical fiber is attached to the sensing tip; and wherein the first optical fiber has a first fiber Bragg grating (FBG) sensor fabricated therein, wherein the first FBG sensor is attached to the elongate sleeve, and wherein the first FBG sensor measures the pressure parameter of the fluid.

In another aspect, the present invention provides sensing device for monitoring a molten molding material flowing into at least one mold cavity via at least one runner channel of a mold platen, the sensing device comprising: a sensing tip; an elongate sleeve, wherein the first extremity of the elongate sleeve is enclosed by the sensing tip; an adaptor for coupling the elongate sleeve to a fiber optic cable, wherein the first extremity of the adaptor is attached to the second extremity of the elongate sleeve; wherein the second extremity of the adaptor is attached to the fiber optic cable; a first optical fiber disposed in the elongate sleeve, wherein a first extremity of the first optical fiber is coupled to first extremity of the adaptor, wherein the second extremity of the optical fiber is attached to the sensing tip; and wherein the first optical fiber has a first fiber Bragg grating (FBG) sensor fabricated therein, wherein the first FBG sensor is attached to the elongate sleeve, and wherein the first FBG sensor measures the temperature parameter of the fluid.

### BRIEF DESCRIPTION OF THE DRAWINGS

Preferred embodiments according to the present invention will now be described with reference to the drawings, in which like reference numerals denote like elements.

FIG. 1 illustrates a perspective view of the mold platen disposed on a base platen.

FIG. 2 illustrates a plan view of the mold platen.

FIG. 3 illustrates a cross-sectional transverse view of the mold platen.

FIG. 4 illustrates a schematic layout of the sensing system.

FIG. 5 illustrates a perspective view of the sensing device.

FIG. 6 illustrates a cross-sectional longitudinal view of the sensing device.

### DETAILED DESCRIPTION OF THE INVENTION

The present invention may be understood more readily by reference to the following detailed description of certain embodiments of the invention.

Various types of sensors have been utilized for monitoring the conditions and environments within composite structures. In the semiconductor industry, the mold is one such structure that requires monitoring of the molding process conditions. This is essential to ensure that the molding process produces quality IC packaging, as was discussed hereinabove. The present invention describes a sensing device for monitoring temperature and pressure in the mold.

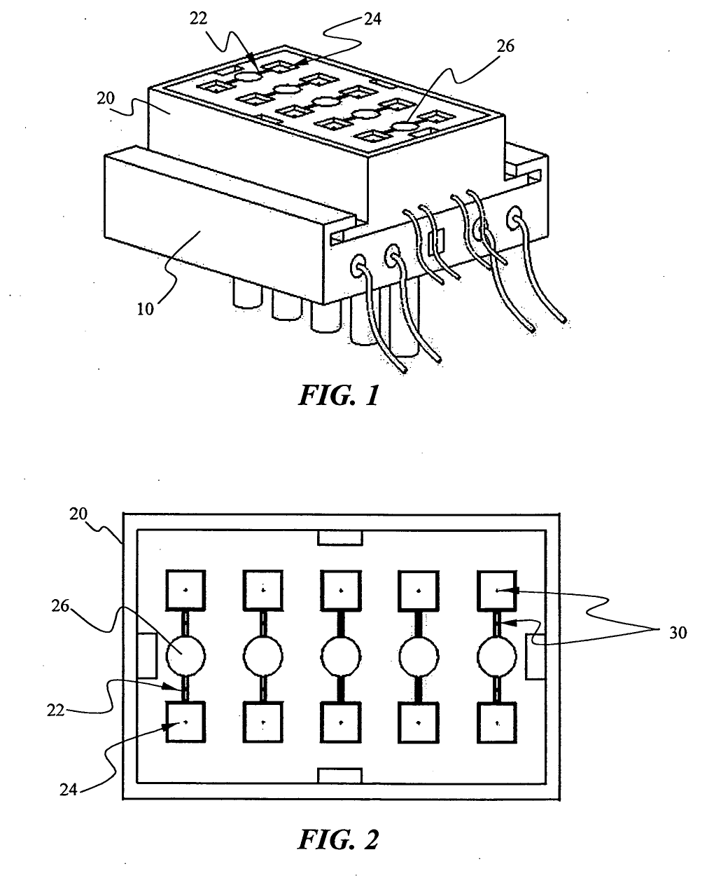

A typical semiconductor mold consists of two mold platens designated as the upper mold platen and lower mold platen. The configurations and operation of the mold platens are known to those skilled in the art and will not be discussed in detail. FIG. 1 illustrates one embodiment of a lower mold platen, referred hereinafter as mold platen 20. The mold platen 20 is mounted on a base platen 10. For exemplary purposes, the mold platen comprises ten mold cavities 24 with respective runner channels 22 disposed thereof.

FIG. 2 shows a plan view of the mold platen 20, wherein each mold cavity 24 and runner channel 22 has a sensing device 30 disposed therein. In this embodiment, the sensing devices 30 are centrally located in the respective mold cavity 24 and runner channel 22, wherein the sensing devices measure or monitor the parameters of the fluid flowing into the mold cavity via the runner channel. Typically, the temperature and pressure of the fluid, for example molten plastics resin, are measured and monitored during the molding process. In other embodiments, the sensing device 30 can be located non-centrally. The sensor device 30 may also be disposed at alternate locations, for example within a plunger 26 or cull bridge (not shown).

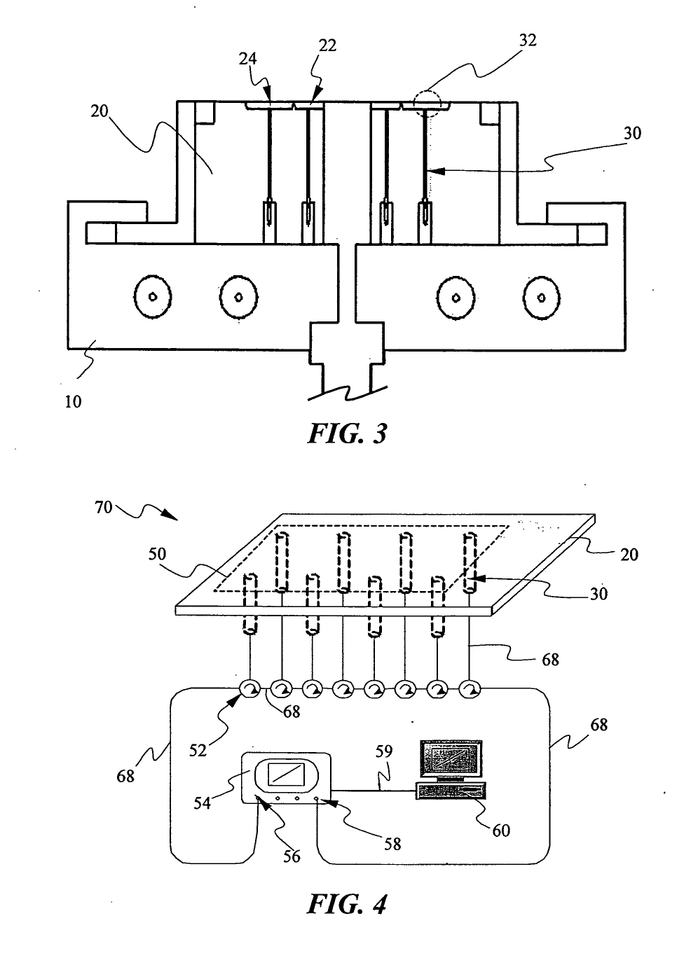

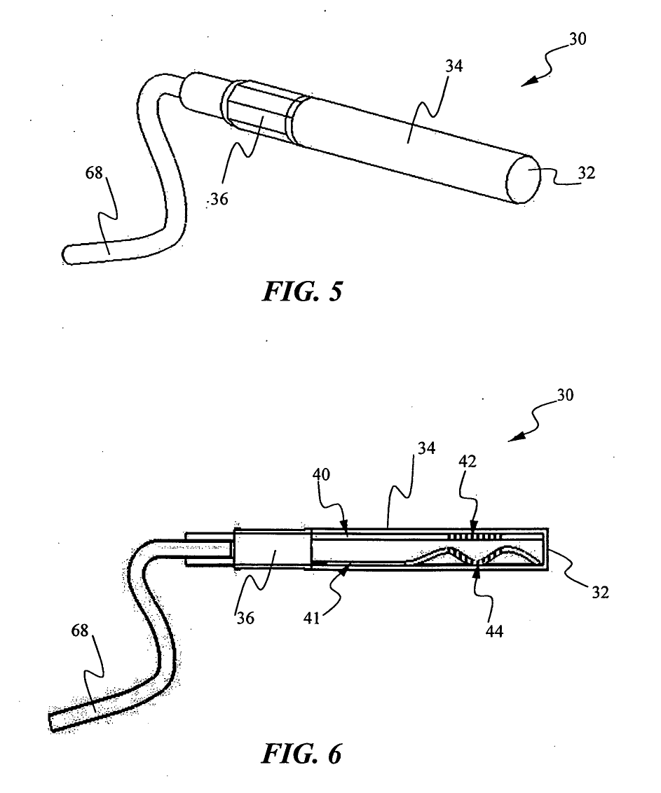

FIG. 5 shows a perspective view of the sensing device 30. In one embodiment, the sensing device 30 comprises a sensing tip 32, an elongate sleeve 34, an adaptor 36, and a fiber optic connector 68. The elongate sleeve 34 is preferably tubular in shape, wherein a sensing tip 32 encloses one extremity of the elongate sleeve, and wherein the opposite extremity of the elongate sleeve is coupled to the adaptor 36. FIG. 3 shows the incorporation of the sensing devices 30 in the mold platen 20, wherein the sensing devices are inserted and attached to pre-formed apertures in the mold platen. The length of sensing device 30 can be predetermined according to the height of the mold platen 20, and wherein the length of sensing device is perpendicularly disposed to the surface of the mold cavity 24 or runner channel 22.

The external diameter of the tubular elongate sleeve 34 is advantageously manipulated to be in the range of 1.0 to 2.0 millimeters to facilitate the incorporation of the sensing device 30 within the small runner channels 22 and mold cavities 24 of the mold platen 20. The elongate sleeve 34 and sensing tip 32 are produced from the same material as the mold platen, for example carbide (D2, DF2) and HRC 70-65.

The sensing tip 32 of the sensing device 30 is preferably at the same level with the mold cavity surface to prevent any unaesthetic marks on the final IC device after molding. An abrasive coating, for example diamond-chrome or titanium nitride TiN, protects the surface of the sensing tip 32 that is in contact with the molten material during molding. In other embodiments, the sensing tip 32 may be slightly protruded with reference to the mold cavity surface for marking or labelling purposes. Both the elongate sleeve 34 and the sensing tip 32 may be produced as a single entity. In another embodiment, the sensing tip 32 can be a separate component mounted on one extremity of the elongate sleeve 34.

In one embodiment, a first optical fiber 40 and a second optical fiber 41 are disposed within the elongate sleeve 34 (see FIG. 6). One extremity of the first optical fiber 40 is adhered to the inner surface of the sensing tip 32, and the opposite extremity attached to the adaptor 36. A Fiber Bragg Grating (FBG) pressure sensor 42 is fabricated within the first optical fiber 40, wherein the total length of FBG pressure sensor 42 is adhered to the inner wall of the elongate sleeve 34, and wherein the FBG pressure sensor provide means for the sensing device to measure pressure. The second optical fiber 41 only has one extremity attached to the adaptor 36, wherein the opposite extremity and entire length of the second optical fiber is unattached in the elongate sleeve 34. A FBG temperature sensor 44 is fabricated within the second optical fiber 41 to provide means for the sensing device to measure temperature. In another embodiment, the sensing device may contain one optical fiber, wherein a FBG sensor is fabricated within the optical fiber for sensing either temperature or pressure. Methods of fabricating FBG pressure and temperature sensors are well known to those skilled in the art and will not be discussed herein.

The sensing system 70 of the present invention shall now be discussed. FIG. 4 illustrates the schematic of the sensing system 70 that comprises a sensor array 50, a plurality of circulator 52, a FBG interrogator unit 54 and a processing unit 60. For exemplary purpose, the sensor array 50 comprises eight sensing devices 30 to measure the temperature and pressure of the mold platen 20. Each sensing device 30 is coupled to a circulator 52 via a fiber optic connector 68, wherein the series of circulators 52 are coupled to each other via fiber optic connectors 68.

The FBG interrogator unit 54 comprises an input channel 56 and output channel 58, wherein the input channel is coupled to one extremity of the series of circulators via a fiber optic connector 68, and wherein the output channel is coupled to the other extremity of the series of circulators via a fiber optic connector 68. During operation, the input channel 56 of the FBG interrogator unit 54 generates a light signal to the sensor array 50. The gratings of the FBG pressure and temperature sensors 42, 44 within the sensing devices 30 reflect this light signal, and the output channel 58 receives the reflected light signal. In another embodiment, an individual light source unit can provide the light signal while an optical spectrum analyzer unit receives the reflected light signal.

The working principles of FBG sensors were discussed in earlier sections, wherein the period between the gratings of the FBG sensors changes due to thermal or mechanical expansion/compression. The expansion or compression of the optical fibers 40, 41 results in a strain on the grating of the respective FBG pressure and temperature sensors 42, 44, wherein the strain can be detected by monitoring the wavelength of the reflected light signal. This particular wavelength is termed as the Bragg wavelength. Each FBG pressure and temperature sensors 42, 44 are prefabricated with different periods of gratings so as to provide different Bragg wavelengths.

During the molding process, molten molding material flowing to the mold cavities 24, via respective runner channels 22, changes the environment around the sensing device 30. The molten molding material flowing across the sensing tip 32 of the sensing device 30 exerts a pressure on the sensing tip 32, wherein the pressure exerted results in the mechanical expansion or compression of the optical fiber 40. Simultaneously, the flow of molten molding material changes the temperature of the sensing device 30, wherein the change in temperature results in a thermal expansion or compression of the optical fiber 41. As was discussed above, the mechanical and thermal expansion/compression of the optical fibers 40, 41 causes strain in the gratings of the FBG pressure and temperature sensors 42, 44, wherein the strain is detected by the reflected light source received by the output channel 58 of the FBG interrogator unit 54. This provides data correlation for the pressure and temperature at each specific location of the sensing device 30.

The FBG interrogator unit 54 is coupled to a processing unit 60, for example a computer, via a signal connection 59. The reflected light source received by the FBG interrogator unit 54 is transformed into a set of data, wherein the set of data is transferred to the processing unit 60. The processing unit 60 further comprises a graphic user interface (GUI) for processing and analyzing the data from the FBG interrogator unit 54. By utilizing the sensor array 50 to measure numerous discrete points in the mold platen 20, the temperature and pressure conditions of the entire mold surface can be mapped using the GUI. This data is analyzed to apply thermal or pressure compensation to the molten molding material flowing in the mold platen 20.

While the foregoing descriptions of the present invention presented certain preferred embodiments, it is to be understood that these descriptions are exemplary and are not intended to limit the scope of the present invention. It is expected that those skilled in the art will perceive variations which, while differing from the foregoing, do not depart from the spirit and scope of the invention as herein described and claimed.

What is claimed is:

1. A sensing device for monitoring a molten molding material flowing into at least a mold cavity via at least a runner channel of a mold platen, the sensing device comprising:
a sensing tip for providing contact with the molten material;
an elongate sleeve having a first extremity and a second extremity, wherein the first extremity of the elongate sleeve is enclosed by the sensing tip;
a fiber optic connector for coupling the sensing device to other optical devices;
an adaptor for coupling the elongate sleeve to the fiber optic connector, wherein the first extremity of the adaptor is attached to the second extremity of the elongate sleeve; and wherein the second extremity of the adaptor is attached to the fiber optic connector;
a first optical fiber disposed in the elongate sleeve, wherein a first extremity of the first optical fiber is coupled to first extremity of the adaptor, wherein the second extremity of the optical fiber is attached to the sensing tip; and
wherein the first optical fiber has a first fiber Bragg grating (FBG) sensor fabricated therein, wherein the first FBG sensor is attached to the elongate sleeve, and wherein the first FBG sensor measures the pressure parameter of the fluid.

2. The sensing device as claimed in claim 1, further comprising:
a second optical fiber located in the elongate sleeve, wherein a first extremity of the second optical fiber is coupled to first extremity of the adaptor; and
wherein the second optical fiber has a second fiber Bragg grating (FBG) sensor fabricated therein, and wherein the second FBG sensor measures the temperature parameter of the fluid.

3. The sensing device as claimed in claim 1, wherein the sensing tip comprises an abrasive coating to protect the surface of the sensing tip in contact with the molten molding material.

4. The sensing device as claimed in claim 1, wherein the elongate sleeve is tubular in shape.

5. The sensing device as claimed in claim 1, wherein the length of the elongate sleeve is perpendicularly disposed to the surface of the at least one mold cavity of a mold platen.

6. The sensing device as claimed in claim 1, wherein the length of the elongate sleeve is perpendicularly disposed to a surface of the at least one runner channel of a mold platen.

7. A sensing device for monitoring a molten molding material flowing into at least one mold cavity via at least one runner channel of a mold platen, the sensing device comprising:
a sensing tip;
an elongate sleeve, wherein the first extremity of the elongate sleeve is enclosed by the sensing tip;
an adaptor for coupling the elongate sleeve to a fiber optic cable, wherein the first extremity of the adaptor is attached to the second extremity of the elongate sleeve; wherein the second extremity of the adaptor is attached to the fiber optic cable;
a first optical fiber disposed in the elongate sleeve, wherein a first extremity of the first optical fiber is coupled to first extremity of the adaptor, wherein the second extremity of the optical fiber is attached to the sensing tip; and
wherein the first optical fiber has a first fiber Bragg grating (FBG) sensor fabricated therein, wherein the first FBG sensor is attached to the elongate sleeve, and wherein the first FBG sensor measures the temperature parameter of the fluid.

8. The sensing device as claimed in claim 7, wherein the sensing tip comprises an abrasive coating to protect the surface of the sensing tip in contact with the molten molding material.

9. The sensing device as claimed in claim 7, wherein the elongate sleeve is tubular in shape.

10. The sensing device as claimed in claim 7, wherein the length of the elongate sleeve is perpendicularly disposed to the surface of the at least one mold cavity of a mold platen.

11. The sensing device as claimed in claim 7, wherein the length of the elongate sleeve is perpendicularly disposed to a surface of the at least one runner channel of a mold platen.
